(19) United States
(12) Patent Application Publication
(10) Pub. No.: US 2004/0203665 A1
(43) Pub. Date: Oct. 14, 2004

(54) Method for dialing telecommunication connections

(76) Inventors: Alexander Aschir, Munchen (DE); Mathias Gabrysch, Munchen (DE)

Correspondence Address: Kevin R. Spivak, Morrison & Foerster LLP, Suite 300, 1650 Tysons Boulevard, McLean, VA, 22102, US

(21) Appl. No.: 10/350,363

(22) Filed: Jan. 24, 2003

(30) Foreign Application Priority Data
Jan. 25, 2002 (DE) 10202922.9

(51) Int. Cl. H04Q 7/20

(52) U.S. Cl. 455/414.1; 455/403

(57) ABSTRACT

A method for dialing telecommunication connections, in which the dialing process is executed on the part of a value-added service unit on the basis of address data stored on the part of the value-added service unit via a network-open user inertace. The method includes control processes by a search control unit by means of voice input and storage and conversion processes to convert alphanumerical address databases into files in a digitized audio format and recognition procedures for keyboard input.

### CLAIM FOR PRIORITY

This application claims priority to Application No. 10202922.9 which was filed in the German language on Jan. 25, 2002.

### TECHNICAL FIELD OF THE INVENTION

The invention relates to a method for dialing telecommunication connections, and in particular, to telecommunication connections dialed using user-related address data.

### BACKGROUND OF THE INVENTION

Telecommunication terminals have storage units for names, addresses, call numbers and other such address data compiled and managed by a user. The user utilizes control elements on the terminals to select from a list of stored address data and to activate dialing procedures to establish a communication connection in a telecommunication network.

Such terminal-side storage of address data is however disadvantageous, if the user has to manage a large number of call numbers for storage and at the same time maintains a number of terminals.

Inputting address data from already existing address lists into each of the terminals involves a great deal of work and in particular is very laborious, lengthy and therefore prone to error due to the different terminal control systems.

### SUMMARY OF THE INVENTION

The invention specifies a method for the terminal-independent management of address data, which allows the user to select from an existing list of address data using the terminal and to activate the associated dialing procedures to establish telecommunication connections in a simple fashion.

In one embodiment of the invention, there is a method including the dialing of telecommunication connections by a value-added service unit, which uses a network-open user interface to execute the necessary dialing procedures to any terminal within a telecommunication network. The value-added service unit includes address data compiled by the user and forwarded in appropriate form, from which an address data item can be selected using a search control unit assigned to the value-added service unit by activation of the control elements on the terminal and/or by voice control on the user side, and a communication connection can be established.

Address data is compiled, input and forwarded on a one-off basis on the part of the user. For this the user creates a file structured appropriately on the basis of data sets and data fields. Where necessary the created file is exported to a data format which is compatible with the value-added service unit. The data is forwarded to the value-added service unit. This operation is preferably carried out by a standard internet transfer protocol like FTP or by email. The address data is subject to a storage procedure on the part of the value-added service unit.

This means that the address data does not have to be input into a plurality of terminals. The address data is available for retrieval within the value-added service unit and can be managed by the user from any terminal.

The value-added service unit, and in particular the retrieval of address data and activation of the dialing process for the required telecommunication connection, are controlled by means of bi-directional communication between the user terminal and the value-added service unit. This involves inputting and generating control commands on the part of the terminal or user, along with acknowledgement on the part of the value-added service unit to the relevant terminal.

The address data initially compiled by the user and forwarded in the form of the structured file is converted within the value-added service unit to a form which ensures that communication, which corresponds to the technical configuration of the terminal and is forwarded by the search control unit of the value-added service unit, is allowed between the terminal and the value-added service unit.

In particular the address data is converted into voice data in an audio file. The address data can then be output acoustically on the part of the terminal or selected by voice control.

For this the converted address data is processed into a suitable form for voice recognition of voice input effected on the terminal side.

Activation of the address data by voice recognition in particular involves recognition of individual letters and/or sound sequences spoken by the user into the terminal and comparison of these with digitized phoneme sequences, generated from the address data, in an audio database in the value-added service unit, which are stored in audio files generated from the address data.

The value-added service unit and/or the search control unit where necessary convert and/or reproduce audio files on the terminal at the same time as the terminal-side control of the value-added service unit. This dynamic creation and/or output of audio data allows the sparing use of storage resources in the value-added service unit, by avoiding duplicated storage of alphanumerical address data and the audio files generated from them.

In another embodiment the value-added service unit or the search control unit can be fitted with a code receiver to execute recognition procedures for keyboard input on the terminal side. Terminals which have an alphanumerical keyboard can then also be used to control search processes within the address data.

For access via the terminal to the value-added service unit there is a clearance and activation process, in which a user-specific call number or another similar form of network addressing is issued on the part of the value-added service unit. This call number or network address is input by the user into the terminal and is used to authenticate the terminal and the user and to assign the terminal in question to the address data stored on the part of the value-added service unit. To permit different terminals assigned to a single user to access the value-added service unit in a uniform manner, the network addressing may be assigned to a number of different terminals.

A loop-type search and complete process is preferably used for user prompting and for the associated search and select processes on the part of the search control unit in the address data files stored in the value-added service unit. Components of an item of information being sought, for example a wanted name, are forwarded on the part of the terminal to the search control unit and completed by this latter from the existing set of address data given. This address data completed by the search control unit is transferred to the terminal and output by this to the user.

The user utilizes a list of completed address data compiled in this way to select the address data item which further restricts the set including the address data sought and thereby gradually further limits the search range, by then inputting a further component of the address data sought, which triggers a further complete and search process by the search control unit within the selection of hits already made.

With voice-based user prompting on the part of the search control unit, the search and complete process takes place in the form of a spelling process. The user inputs a sound sequence verbally into the terminal, which is assigned to a letter of the alphabet, this sound is forwarded to the search control unit, the spoken letter is recognized by the search control unit, the recognized letter is completed by the search control unit from the store of available address data, an acknowledgement is sent to the terminal of the sound sequences generated from the store of address data on the part of the search control unit and there is a voice output at the terminal for the user. A further letter can be input by the user to delimit these sound sequences until the address data sought is delimited with adequate precision.

Identification codes are preferably assigned to the address data and these can be dialed directly on the part of the user via the terminal. This makes it possible to abbreviate the spelling process by the user-side inputting and forwarding of voice or keyboard-input based control signals assigned to the identification codes, to dial address data items directly and thereby to limit the time required for the search and complete process.

Further telecommunication processes, which can be activated within the value-added service unit and/or the search control unit, for example callback functions, short messages, dispatch of electronic and/or voice-based business cards to another terminal and other similar services can be activated by the user by means of terminal-side keyboard and/or input voice commands.

### BRIEF DESCRIPTION OF THE DRAWINGS

The method according to the invention is described in more detail using an example of an application. The attached figures are used for clarification. The same references are used for the same method components or those with the same effect. These show:

FIG. 1 an overview of interactions between the value-added service unit, network-open user interface, telecommunication network and terminals.

FIG. 2 a diagrammatic flow chart of a voice-based recognition process for address data.

### DETAILED DESCRIPTION OF THE INVENTION

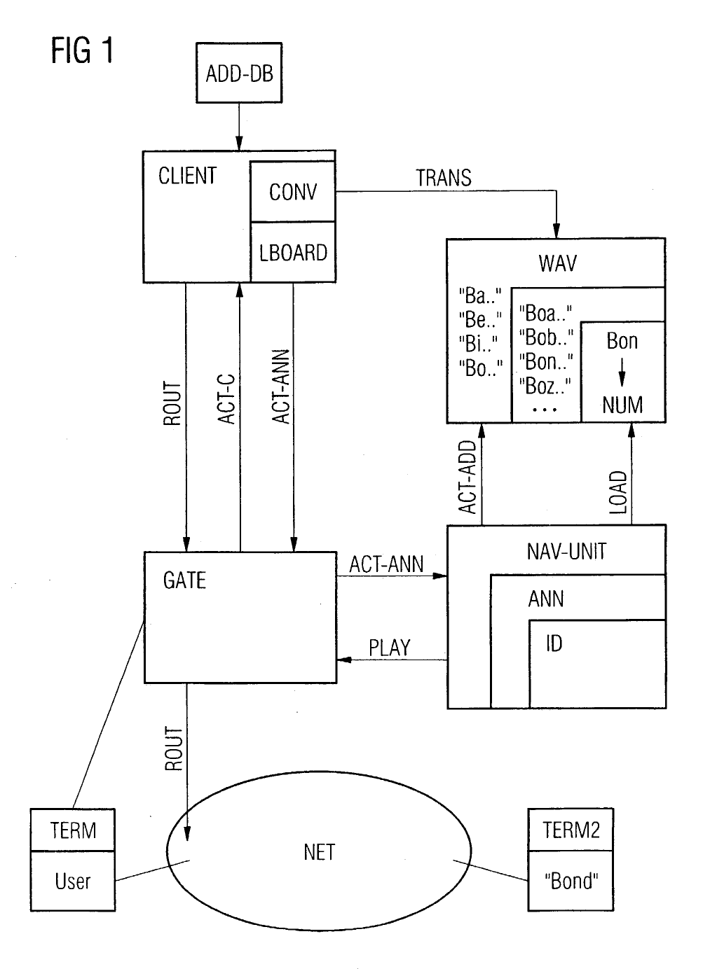

FIG. 1 shows the interactions in diagrammatic form between the value-added service unit CLIENT, the network-open user interface GATE together with the storage units for audio files WAV assigned to the value-added service unit and the search control unit NAV-UNIT. A user-side terminal TERM and a second terminal TERM2 assigned to a further user communicate with each other via a telecommunication network NET.

The user compiles an address database ADD-DB in an appropriate file format and forwards this to the value-added service unit CLIENT. The standard transfer channels according to the prior art, in particular FTP or email, can be used for the forwarding operation.

It is preferable for the file format to have a database structure with data sets and data fields. The data sets represent the relevant address data item ADD, while the data fields contain, for example, name and telephone number preferably in the form of a character string or as a numerical expression. Audio files are created within the value-added service unit CLIENT by means of a conversion process CONV and these are transferred in a transfer process TRANS into an audio database WAV.

Depending on the configuration of the method, the conversion CONV and transfer TRANS may take place in real time during the interaction of the terminal TERM with the value-added service unit CLIENT and/or the search control unit NAV-UNIT or may already be terminated before a first interaction between the terminal and the value-added service unit.

The audio database WAV and the value-added service unit CLIENT are assigned a search control unit NAV-UNIT, which serves as the interface between the terminal and the value-added service unit CLIENT for search and selection processes within the address data ADD via communication with the terminal TERM.

For access to and selection of the address data ADD, user-side dialing of a user-specific previously agreed call number is used to activate a bi-directional connection between the terminal TERM and the value-added service unit CLIENT. Establishment of the connection between the terminal TERM and the value-added service unit CLIENT can in particular be managed via a network-open user interface GATE. The programmable API interfaces available according to the prior art can be used as the network-open interface after standardization in the context of Parlay, OSA or JAIN.

An activation process ACT-C takes place in respect of the value-added service unit CLIENT. The activation process ACT-C can in particular include searches for other services or resources available within the value-added service unit CLIENT. It is also possible to execute configuration procedures as part of the activation process ACT-C, in order to achieve optimum personalization of the use of the value-added service unit CLIENT. This can for example include setting up a password, a PIN, the setting up or deactivation of other services, in particular the dispatch of electronic or acoustic business cards, short messages, voice settings to control the value-added service unit, charge status data and other similar services.

In the application example given here address data selection is activated with the activation process ACT-C. If there is voice-based selection of address data, first activation of a voice output ACT-ANN of the search control unit NAV-UNIT also takes place A voice output PLAY is used to confirm activation of the search control unit NAV-UNIT and to give voice notification to the user at the terminal TERM.

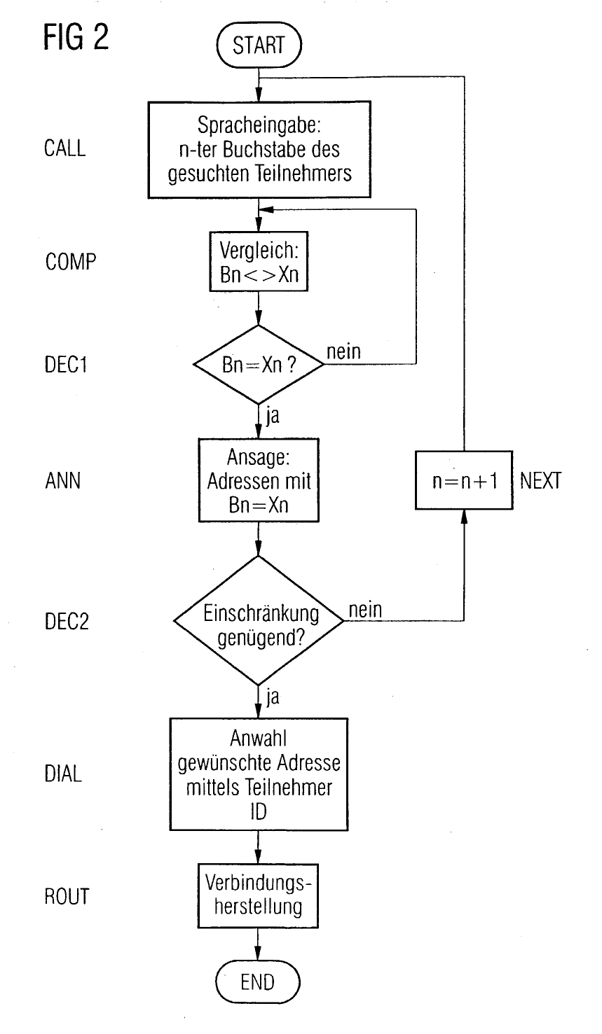

The user activates the search process for required address data ADD by voice via the terminal TERM. The precise search process is described in more detail in the annex in the notes to FIG. 2.

The voice-based activation process ACT-ANN, which is forwarded to a voice recognition unit LBOARD in the value-added service unit, is used to start the search process for the address data item, with the search activation unit NAV-UNIT within the audio database WAV executing database activation ACT-ADD. The audio database WAV can be permanently available or it can be generated at the same time during the search process from the address database ADD by means of a conversion process CONV and generated by a transfer process TRANS of the audio files. Continued voice input ACT-ANN on the part of the user into the terminal TERM, voice recognition LBOARD of this on the part of the value-added service unit CLIENT, subsequent selection LOAD on the part of the search control unit NAV-UNIT within the audio database WAV and voice output PLAY to the terminal TERM results in the execution of a loop-type search/complete process between the user or terminal TERM on the one hand and the value-added service unit CLIENT on the other hand.

The announcements ANN in particular output the names of the data fields stored in the address database ADD-DB, linked to a subscriber identification ID generated by the search control unit NAV-UNIT, via an acoustic voice output process PLAY to the terminal TERM and are received acoustically by the user and understood in voice form.

When the address data item ADD sought is adequately delimited in the view of the user, the user executes the user-side voice input of the subscriber identification ID via the terminal TERM, thereby obtaining a selection of hits for the required address data item ADD.

As an option, the value-added service unit CLIENT is activated on the part of the user via a voice input to a connection set-up ROUT between the terminals TERM of the user and TERM2 of the required subscriber by supplying the network resources required to establish the connection to the value-added service unit CLIENT via the network-open user interface GATE.

The voice-based search process for an address data item ADD within the address database ADD-DB is described below using the flow chart in FIG. 2.

The voice-based search process takes place in the form of a search/complete procedure, in which a spelling process is executed in stages by means of voice input. This will be explained using the example of a search process, in which an address data item ADD is sought, which contains the name “Bond”.

The search procedure starts with a voice input CALL of the first letter of the name of the address data item ADD sought and associated voice recognition, which has already been described in FIG. 1 and the explanation of this. A comparison COMP is made of the letters Bn input in this instance and the sound Xn from the audio file using the audio data stored in the audio database ADD-DB. If the initial sound Xn of the name from the address data item ADD currently being verified corresponds to the voice input Bn, therefore Bn=Xn, address data items ADD, the names of which start with the sound Bn, are output in voice form. This decision is marked in FIG. 2 with the reference DEC1.

In the above example the user inputs the letter “B” in voice form. The voice input is recognized by the voice recognition unit of the value-added service unit. Address data items ADD within the address database ADD-DB and the audio database WAV generated from this, the name of which includes the sound “B” at the beginning, are retrieved by the search procedure. Then the address data items ADD in audio format are announced in conjunction with a voice output PLAY at the user terminal, the names of which start with the sound “B”. The voice output is assigned a subscriber identification ID, which simplifies the further selection of the address data item sought.

A decision DEC2 is taken by the user, whether the output selection of address data ADD is adequately delimited with the initial sound Bn. If this is not the case, the next letter NEXT is input in voice form, and a search is executed within the already selected address data ADD for an address data item ADD, the name of which includes the input letters Bn+1 as the digitized sound Xn+1. If, in this second stage of the search procedure, the address data item ADD sought is adequately delimited, it is possible for the user to make a selection DIAL by means of subscriber identification ID to the address data item ADD sought, by selecting the address data item ADD linked to the subscriber identification ID either by voice or keyboard input.

In the example given here the address data items ADD, the names of which start with a “B”, are listed by the search control unit,. In this case these are the names, the sounds of which continue as “Ba . . . ”, “Be . . . ”, . . . , “Bo . . . ” etc. If this result is deemed to be too extensive on the part of the user, the user inputs the second letter of the name sought “Bond”: “O”. Then the names are retrieved from the already filtered address data ADD, the sounds of which continue as “Bo . . . ”. These are also continuously- output by voice in list form with subscriber identifications ID. In the example given here the following can be output as voice output on the user terminal: “Bolton, ID=1”, “Bond, ID=5”, “Bornemann, ID=13”.

In this example the second search stage delimits the required address data adequately. The user can use the subscriber identification ID to select the required address data item from the remaining list of search results either by voice input “ID 5” or by keyboard input “5”: “Bond, James. Tel. no. 007 3 424 566”.

The value-added service unit then selects the terminal TERM 2 assigned to the required subscriber and establishes a connection, with the call number stored within the address data item ADD being dialed on the part of the value-added service unit CLIENT. For this the value-added service unit CLIENT is provided with network resources via a network-open user interface GATE

In the example here the connection to the user terminal “Bond, James” addressed at “Tel. no. 007 3 424 566” is set up by the value-added service unit dialing the call number “007 3 424 566”.

### REFERENCES FOR DRAWING FIGURES

ACT-ANN Announcement activation

ACT-C Activation of value-added service provider

AD-DB Address database

ADD Address data

ANN Announcement of address data with Bn=Xn

CALL Voice input of a letter Bn by user

CLIENT Value-added service unit

CONV Conversion of alphanumerical address data into audio file data

DEC1 1. Decision re correspondence of a sound sequence

DEC2 2. Decision re adequate delimitation

DIAL Dialing of an address data item on user or terminal side using subscriber identification

GATE Network-open user interface

ID Subscriber identification

LBOARD Voice recognition unit

NAV-UNIT Search control unit

NET Telecommunication network

NEXT Request to input a further letter by voice

NUM Call number

PLAY Acoustic voice output at terminal

ROUT Establishment of a telecommunication connection

TERM Terminal

TERM2 Terminal of dialed subscriber

TRANS Transfer to audio files of converted address data in an audio database

WAV Audio database

Bn Sound sequence of an nth letter spelled by voice input

Xn Available digitized sound

ENGLISH TRANSLATION FOR DRAWING FIG. 2

| | |
|---|---|
| | START |
| CALL | Voice input: nth letter of subscriber sought |
| COMP | Comparison: Bn <> Xn |
| DEC1 | Bn = Xn No |
| | Yes |
| ANN | Announcement: addresses with Bn = Xn n = n + 1 |
| | NEXT |
| DEC2 | Delimitation adequate? No |
| | Yes |
| DIAL | Dialing of required address using subscriber ID |
| ROUT | Establishment of connection |
| | END |

What is claimed is:

1. A method for dialing telecommunication connections, comprising dialing one or more telecommunication connections using user-related address data stored on the part of a value-added service unit, interacting with a search control unit via a network-open user interface.

2. The method according to claim 1, wherein the user-related address data is compiled by the user in the form of a file structured based on data sets and data fields, exported and read and stored by the value-added service unit.

3. The method according to claim 1, wherein a bi-directional communication controlling the value-added service unit takes place via the network-open user interface between the user terminal and the value-added service unit.

4. The method according to claim 3, wherein the user-related address data is converted by the value-added service unit between the value-added service unit and the search control unit, such that a communication appropriate for technical configuration of the user terminal mediated by the search control unit occurs between the user terminal and the value-added service unit.

5. The method according to claim 4, wherein the user-related address data is converted by the value-added service unit, which generates a voice output by the search control unit on a voice-based user terminal.

6. The method according to claim 4, wherein sound recognition of letters spoken via the user terminal is executed by a sound recognition unit assigned to the search control unit and/or the value-added service unit.

7. The method according to claim 1, wherein the value-added service unit and/or the search control unit execute a conversion of text-based data into audio data and/or load and/or output audio files at the same time as the value-added service unit is controlled on the terminal side.

8. The method according to claim 1, wherein the value-added service unit and/or the search control unit recognizes keyboard input at the user terminal of assigned keyboard codes.

9. The method according to claim 1, further comprising a clearance process for a service or terminal-specific call number or similar network address, on the basis of which control of the value-added service unit is initialized via the services associated therewith.

10. The method according to claim 1, wherein with user prompting by the search control unit by means of the user-defined address data stored within the value-added service unit, a loop-type complete and search process is used to retrieve the required address data.

11. The method according to claim 10, wherein with voice-based user prompting by the search control unit a spelling process is used, in which a sequence of letters transferred on the part of the user by means of the user terminal is compared in stages with the audio data generated from the address data, with delimitation by stages of the sound sequence sought and an associated character string.

12. method according to claim 1, wherein other available telecomunication services which can be executed by and/or have to be initiated by the value-added service unit can be activated and/or retrieved via the search control unit by means of keyboard and/or voice commands by the user terminal.
